(19) United States
(12) Patent Application Publication
(10) Pub. No.: US 2023/0367188 A1
(43) Pub. Date: Nov. 16, 2023

(54) VRM Video Recording Mirror

(71) Applicants: Samuel IIie Bucur, Sanford, NC (US); Eunice Bucur, Sanford, NC (US)

(72) Inventors: Samuel IIie Bucur, Sanford, NC (US); Eunice Bucur, Sanford, NC (US)

(21) Appl. No.: 17/815,620

(22) Filed: Jul. 28, 2022

Related U.S. Application Data
(60) Provisional application No. 63/228,116, filed on Aug. 1, 2021.

(51) Int. Cl. G03B 17/56; G02B 7/182; A47G 1/02; F16M 13/02

(52) U.S. Cl. CPC G03B 17/565; G02B 7/182; A47G 1/02; F16M 13/022; A45C 11/00

(57) ABSTRACT

A video recording mirror includes a 2-way mirror. The 2-way mirror is configured to be positioned over a lens of a camera. In select embodiments, a clip is included that has the 2-way mirror attached thereto. The clip is configured to clip onto a cell phone, a computer, a tablet, or the like. Wherein, once clipped onto the cell phone, the computer, the tablet, or the like, the clip is configured to position the 2-way mirror over the lens of the camera of the cell phone, tablet, camera, or the like. Wherein the 2-way mirror is configured to provide a focal point to obtain feedback to a user to look at themselves while recording themselves or even taking a selfie.

### SPECIFICATIONS

Purpose: Being able to look straight at the audience through the mirror. You are viewing yourself as you look straight into the cell phone/computer camera. Prevents a person's eyes from wandering all over the place and increases confidence as you are recording knowing you are looking at yourself into the mirror while speaking.

List all parts of the Invention: These and other features of the instant video recording mirror will become more apparent to one skilled in the art from the prior Summary, and following Brief Description, and Claims when read in light of accompanying Detailed Drawings:
a. Clip (attached to camera: cell phone or computer)
b. Two way mirror

### List of Advantages of your Invention

A feature of the present disclosure is its ability to allow yourself a focal point and obtain feedback being able to look at yourself while recording yourself or even taking a selfie. Many people with YouTube channels have a hard time looking straight at the pinhole camera and it is noticeable and distracting. Having a two-way mirror clipped over the pinhole camera allows you to look confidently at yourself and straight into the camera, thus straight to your viewers. This adds to the professionalism of recording and boosts the users confidence. Can also be used on the back of the camera (which usually has a better camera) but no ability to see yourself.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numbers denote similar structure and refer to like elements throughout, and in which:

FIG. 1 is a perspective view of a rough prototype of the video recording mirror according to select embodiments of the instant disclosure;

FIG. 2 is a side environmental view of the rough prototype of the video recording mirror of FIG. 1 attached to a cell phone;

FIG. 3 is a rear environmental view of a cell phone with the rough prototype of the video recording mirror of FIG. 1 attached to the back camera of the cell phone;

FIG. 4 is a front environmental view of a cell phone with the rough prototype of the video recording mirror of FIG. 1 attached to the front camera of the cell phone; and

FIG. 5 is a rear environmental view of the rough prototype of the video recording mirror of FIG. 1 attached to a cell phone on the back camera of the cell phone showing the reflection of the user in the 2-way mirror while in use recording the user.

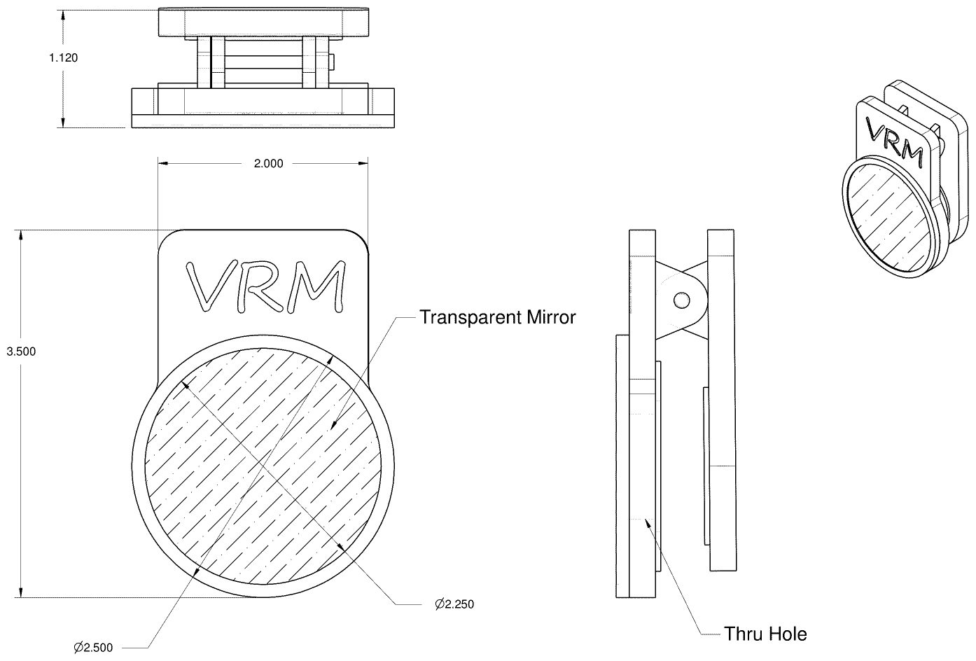

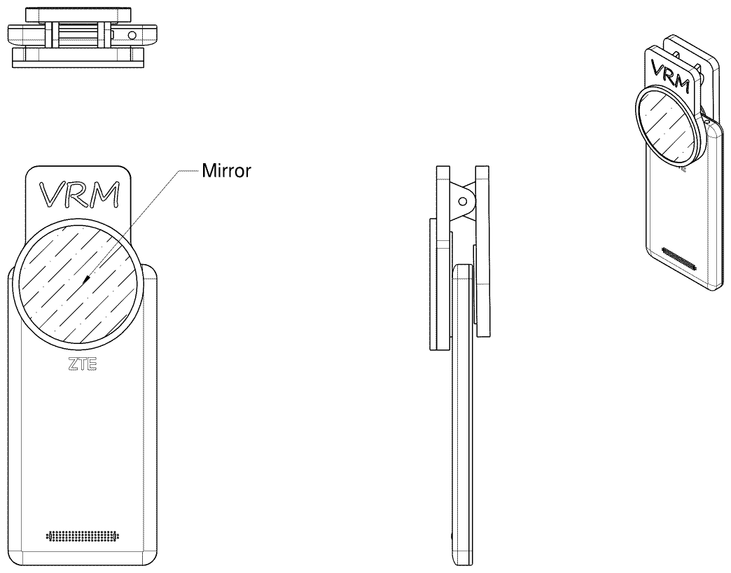

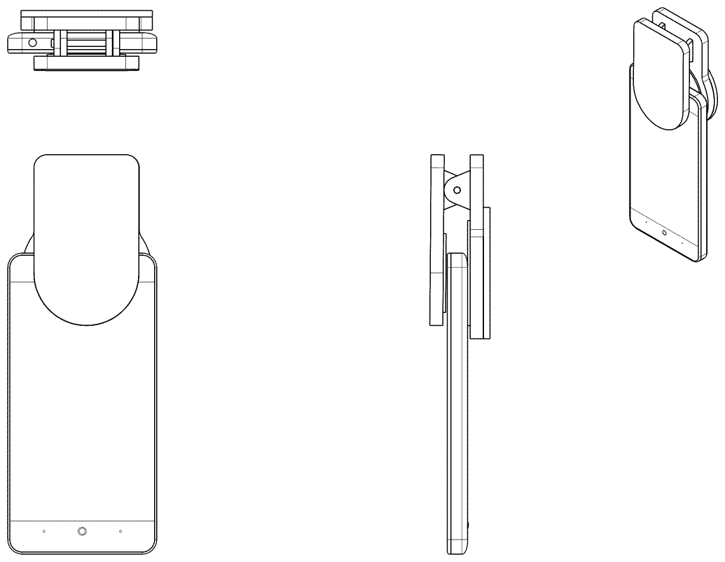

It is to be noted that the drawings presented are intended solely for the purpose of illustration and that they are, therefore, neither desired nor intended to limit the disclosure to any or all the exact details of construction shown, except insofar as they may be deemed essential to the claimed disclosure.

### Brief Summary

A plastic or aluminum clip that clips onto a cell phone or computer. The plastic clip has a circular threaded housing that the centerpiece will be attached to. From that centerpiece a two way mirror piece will be attached by clips on both ends that can easily be removed for other styled mirrors to be placed in its place.

Basically, the idea, is a clip that attaches onto a cell phone that is configured to put a 2-way mirror over the camera lens on either side. That way, when one is filming a video of themselves, they will focus their eyes on the mirror to see their reflection and don't look like they are staring off into the distance.

In addition, the disclosed embodiment in the Figures, below are three different embodiments that are contemplated by the instant disclosure:
1. A plastic or aluminum clip that clips onto a cell phone or computer. The plastic clip has a circular threaded housing that a centerpiece will be attached to. From that centerpiece a two way mirror piece will be attached by clips on both ends that can easily be removed for other styled mirrors to be place in its place.
2. A phone cover case that would fit cellphones with a built-on square two way mirror over the camera on the back side that lifts up, pivots, and drops over the front camera of the phone.
3. A universal clip from side to side on top of the cellphone. That clip contains the two-way mirror which slides up and down on small track. It also flips back and slides up and down on the back of the camera as well.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitations on the order of the steps of that method. Many modifications and other embodiments will come to mind to one skilled in the art to which this disclosure pertains having the benefit of teaching presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A video recording mirror comprising:
a 2-way mirror configured to be positioned over a lens of a camera.

2. The video recording mirror of claim 1 further comprising:
a clip including the 2-way mirror attached thereto, the clip is configured to clip onto a cell phone, a computer, a tablet, or the like, wherein once clipped onto the cell phone, the computer, the tablet, or the like, the clip is configured to position the 2-way mirror over the lens of the camera of the cell phone, tablet, camera, or the like.

3. The video recording mirror of any one of claims 1-2, wherein the 2-way mirror is configured to provide a focal point to obtain feedback to a user to look at themselves while recording themselves or even taking a selfie.
